(19) United States
(12) Patent Application Publication
(10) Pub. No.: US 2023/0155669 A1
(43) Pub. Date: May 18, 2023

(54) Beam Reconfiguration in a Wireless Communication Network

(71) Applicant: Telefonaktiebolaget LM Ericsson (publ), Stockholm (SE)

(72) Inventors: Olof Liberg, Enskede (SE); Xingqin Lin, San José, CA (US); Fredrik Huss, Sundbyberg (SE)

(21) Appl. No.: 17/917,423

(22) PCT Filed: Apr. 9, 2021
(86) PCT No.: PCT/SE2021/050324

§ 371 Date: Oct. 6, 2022

Related U.S. Application Data
(60) Provisional application No. 63/008,317, filed on Apr. 10, 2020.

(51) Int. Cl. H04B 7/185

(52) U.S. Cl. CPC H04B 7/18513; H04B 7/18519

(57) ABSTRACT

A wireless device (18) is configured for use in a wireless communication network (10), e.g., a non-terrestrial network. The wireless device (18) is configured to receive, from a network node (20) in the wireless communication network (10), signaling (22) that indicates reconfiguration of a beam (16) serving the wireless device (18). The wireless device (18) in some embodiments is also configured to, responsive to receiving the signaling (22), reacquire time and/or frequency synchronization for the beam (16), e.g., to account for the indicated reconfiguration of the beam (16).

### TECHNICAL FIELD

The present application relates generally to a wireless communication network and relates more particularly to beam reconfiguration in such a network.

### BACKGROUND

A non-terrestrial network can provide wireless communication service over a wider area of Earth than a terrestrial network, e.g., so that service is more independent of location. To provide this coverage, the non-terrestrial network may for example include a multiple beam satellite that provides service using a number of beams. These beams may be spot beams that cover discrete and separate areas, e.g., the size of a city. But the satellite may dynamically reconfigure the beams to adapt to changing service needs, e.g., as dictated by changing satellite coverage or traffic demand. The satellite may for instance reconfigure the location covered by the beams, the size of the beams, and/or the power radiated in each of the beams. Providing satellite coverage in this way advantageously offers high frequency reuse, but requires significant flexibility in beam reconfiguration.

### SUMMARY

According to some embodiments herein, a wireless communication network informs a wireless device about reconfiguration of a beam serving the wireless device. The network may for example inform the wireless device about how and/or when the serving beam is to be, or has been, reconfigured. This way, rather than insulating the wireless device from knowledge of the beam reconfiguration, some embodiments equip the wireless device with knowledge of the beam reconfiguration so as to trigger the wireless device to reacquire time and/or frequency synchronization for the beam. Reacquiring synchronization for the beam in this way may thereby adaptively account for beam reconfiguration that would have otherwise jeopardized synchronization. These and other embodiments may prove especially applicable in a non-terrestrial network. Indeed, in this case, embodiments herein may advantageously preserve flexibility to reconfigure beams of a multiple spot beam satellite (e.g., for realizing high frequency reuse and data rate) while also preserving time and/or frequency synchronization.

Generally, though, embodiments herein include a method performed by a wireless device configured for use in a wireless communication network, e.g., a non-terrestrial network. The method comprises receiving, from a network node in the wireless communication network, signaling that indicates reconfiguration of a beam serving the wireless device. The method in some embodiments also comprises, based on the signaling, reacquiring time and/or frequency synchronization for the beam, e.g., to account for the indicated reconfiguration of the beam.

In some embodiments, the signaling indicates that the reconfiguration of the beam is to occur.

In some embodiments, the signaling indicates that the reconfiguration of the beam is to occur at or after a certain time.

In some embodiments, the signaling indicates a value of a beam activity timer. This beam activity timer indicates when the beam is to be reconfigured with a default configuration. In this case, the method may further comprise starting or restarting the beam activity timer with the indicated value upon performing downlink reception or uplink transmission on the beam using a non-default configuration of the beam. And reacquiring time and/or frequency synchronization may comprise reacquiring time and/or frequency synchronization for the beam responsive to expiration of the timer.

In some embodiments, the signaling indicates a change in a reference location of the beam, where the reference location is a location which serves as a common reference for time and/or frequency synchronization.

In some embodiments, the signaling indicates a change in an ephemeris of a satellite providing the beam.

In some embodiments, the signaling implicitly indicates reconfiguration of the beam by indicating a change in an identity of a cell served by the beam or a change in a service link supporting the beam.

In some embodiments, the signaling is broadcasted to wireless devices served by the beam.

In some embodiments, the signaling comprises system information.

In some embodiments, the signaling comprises Radio Resource Control signaling, or a Medium Access Control, MAC, Control Element command, or a Downlink Control Information message, or a combination thereof.

In some embodiments, the reconfiguration changes a footprint of and/or elevation angle of the beam.

In some embodiments, the reconfiguration comprises a switch of a service link supporting the beam from a source satellite to a target satellite.

In some embodiments, the reconfiguration comprises a reconfiguration of a gain or pointing direction of an antenna providing the beam.

In some embodiments, reacquiring time and/or frequency synchronization for the beam comprises reacquiring downlink time and/or frequency synchronization for the beam.

In some embodiments, reacquiring time and/or frequency synchronization for the beam comprises reacquiring uplink time and/or frequency synchronization for the beam.

In some embodiments, the method further comprises transmitting or receiving a transmission on the beam based on the reacquired time and/or frequency synchronization for the beam.

In some embodiments, the wireless communication network is a non-terrestrial wireless communication network.

Embodiments herein also include a corresponding method performed by a radio network node configured for use in a wireless communication network, e.g., a non-terrestrial network. The method comprises transmitting, from the radio network node to a wireless device, signaling that indicates reconfiguration of a beam serving the wireless device. The reconfiguration may for example impact time and/or frequency synchronization for the beam. In some embodiments, the signaling is configured to trigger the wireless device to reacquire time and/or frequency synchronization for the beam. In some embodiments, therefore, the method also comprises, after transmitting the signaling, receiving signaling from the wireless device that triggers the radio network node to transmit a timing advance and/or a frequency correction to the wireless device.

In some embodiments, the signaling indicates that the reconfiguration of the beam is to occur. In this case, the method may comprise transmitting the signaling before performing the reconfiguration of the beam.

In some embodiments, the signaling indicates that the reconfiguration of the beam is to occur at or after a certain time.

In some embodiments, the signaling indicates a value of a beam activity timer that controls when the beam is to be reconfigured with a default configuration. In this case, the beam activity timer is to be started or restarted with the indicated value upon performing downlink reception or uplink transmission on the beam using a non-default configuration of the beam. And the beam is to be reconfigured with the default configuration responsive to expiration of the timer.

In some embodiments, the signaling indicates a change in a reference location of the beam, where the reference location is a location which serves as a common reference for time and/or frequency synchronization.

In some embodiments, the signaling indicates a change in an ephemeris of a satellite providing the beam.

In some embodiments, the signaling implicitly indicates reconfiguration of the beam by indicating a change in an identity of a cell served by the beam or a change in a service link supporting the beam.

In some embodiments, transmitting the signaling comprises broadcasting the signaling.

In some embodiments, the signaling comprises system information.

In some embodiments, the signaling comprises Radio Resource Control signaling, or a Medium Access Control, MAC, Control Element command, or a Downlink Control Information message, or a combination thereof.

In some embodiments, the reconfiguration changes a footprint of and/or elevation angle of the beam.

In some embodiments, the reconfiguration comprises a switch of a service link supporting the beam from a source satellite to a target satellite.

In some embodiments, the reconfiguration comprises a reconfiguration of a gain or pointing direction of an antenna providing the beam.

In some embodiments, the method further comprises, after transmitting the signaling, receiving signaling from the wireless device that triggers the network node to transmit a timing advance and/or a frequency correction to the wireless device.

In some embodiments, the time and/or frequency synchronization for the beam comprises downlink time and/or frequency synchronization.

In some embodiments, the time and/or frequency synchronization for the beam comprises uplink time and/or frequency synchronization.

In some embodiments, reconfiguration of the beam changes a configuration of the beam from an old configuration to a new configuration. In this case, the method may further comprise simultaneously transmitting the beam with the old configuration and transmitting the beam with the new configuration; and steering the wireless device to connect to the beam with the new configuration. In some embodiments, such steering comprises transmitting the beam with the new configuration with a transmit power that is higher than a transmit power with which the network node transmits the beam with the old configuration. In other embodiments, such steering comprises transmitting a Physical Downlink Control Channel, PDCCH, order that triggers the wireless device to perform random access to the beam with the new configuration.

In some embodiments, the wireless communication network is a non-terrestrial wireless communication network.

In some embodiments, the signaling is to trigger the wireless device to reacquire time and/or frequency synchronization for the beam.

Embodiments herein further include corresponding apparatus, computer programs, and carriers of those computer programs. For example, embodiments herein include a wireless device configured for use in a wireless communication network, e.g., a non-terrestrial network. The wireless device is configured to receive, from a network node in the wireless communication network, signaling that indicates reconfiguration of a beam serving the wireless device. The wireless device in some embodiments is also configured to, responsive to receiving the signaling, reacquire time and/or frequency synchronization for the beam, e.g., to account for the indicated reconfiguration of the beam.

Embodiments further include a radio network node configured for use in a wireless communication network, e.g., a non-terrestrial network. The radio network node is configured to transmit, from the radio network node to a wireless device, signaling that indicates reconfiguration of a beam serving the wireless device. The reconfiguration may for example impact time and/or frequency synchronization for the beam. In some embodiments, the signaling is configured to trigger the wireless device to reacquire time and/or frequency synchronization for the beam. In some embodiments, therefore, the radio network node is also configured to, after transmitting the signaling, receive signaling from the wireless device that triggers the radio network node to transmit a timing advance and/or a frequency correction to the wireless device.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a block diagram of a wireless communication network in the form of a satellite network with bent pipe transponders according to some embodiments.

FIG. 3 is a block diagram of a wireless device shift of uplink and downlink frame structures according to a timing advance command, according to some embodiments.

FIG. 4 is a block diagram of a base station and wireless device shift of uplink and downlink frame structures according to some embodiments.

FIG. 5 is a block diagram of a service link switch according to some embodiments.

FIG. 6 is a block diagram of a service link switch that impacts time and/or frequency synchronization according to some embodiments.

FIG. 7 is a logic flow diagram of a method performed by a wireless device according to some embodiments.

FIG. 8 is a logic flow diagram of a method performed by a network node according to some embodiments.

FIG. 9 is a block diagram of a wireless device according to some embodiments.

FIG. 10 is a block diagram of a network node according to some embodiments.

FIG. 11 is a block diagram of a wireless communication network according to some embodiments.

FIG. 12 is a block diagram of a user equipment according to some embodiments.

FIG. 13 is a block diagram of a virtualization environment according to some embodiments.

FIG. 14 is a block diagram of a communication network with a host computer according to some embodiments.

FIG. 15 is a block diagram of a host computer according to some embodiments.

FIG. 16 is a flowchart illustrating a method implemented in a communication system, in accordance with one embodiment.

FIG. 17 is a flowchart illustrating a method implemented in a communication system, in accordance with one embodiment.

FIG. 18 is a flowchart illustrating a method implemented in a communication system, in accordance with one embodiment.

FIG. 19 is a flowchart illustrating a method implemented in a communication system, in accordance with one embodiment.

### DETAILED DESCRIPTION

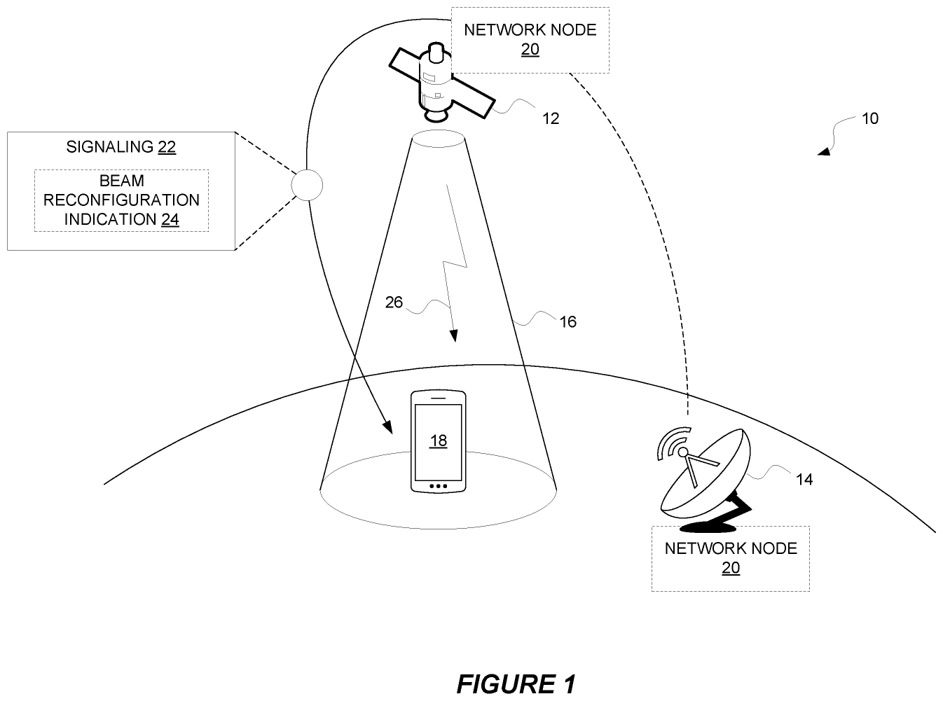

FIG. 1 shows a wireless communication network 10 in the form of a non-terrestrial network. The wireless communication network 10 as shown includes a satellite 12 (e.g., a communications satellite) and an earth-based gateway 14 that connects the satellite 12 to a base station or a core network. The satellite 12, potentially in cooperation with the earth-based gateway 14, provides a beam 16 which serves a wireless device 18. The satellite 12 may for example be equipped with a phased array antenna, an electronically steerable parabolic antenna, or the like, in order to form the beam 16 in a spatial dimension. In a phased array antenna implementation, for instance, the beam 16 may be formed via antenna precoding. The beam 16 in some embodiments is a spot beam, e.g., which may be one of multiple spot beams in case the satellite 12 is a multiple spot beam satellite. In these and other embodiments, the beam 16 may serve or otherwise be associated with a cell, as identified by a physical cell identity. Alternatively or additionally, the beam 16 may be identified by a beam identity and/or be associated with one or more synchronization signals.

The beam 16 may be configured in any number of respects, e.g., in terms of one or more configuration parameters. The beam 16 may for example be configured in terms of a gain and/or pointing direction of an antenna providing the beam 16. Increasing the antenna gain may for instance correspond to reducing the half-power beam width and/or the cell size, e.g., in order to improve the link budget in the cell. Alternatively or additionally, the antenna pointing direction may be changed (e.g., by adjusting precoding weights) to refocus the beam 16 towards an area of high mobile traffic density, e.g., to improve the link budget in that area. The beam 16 in these and other embodiments may accordingly be configured in terms of a footprint of the beam 16 (e.g., a location, size, or area of the beam 16) and/or an elevation angle of the beam 16. Configuration of the beam 16 may alternatively or additionally be specified in terms of a center of the beam's footprint or other reference point of the beam 16. In still other embodiments, the beam 16 may be configured in terms of which satellite or service link serves the beam 16.

At any point in time after the beam 16 is configured initially for serving the wireless device 18, the beam 16 may be reconfigured. Reconfiguration of the beam 16 in this regard means that one or more parameters governing the configuration of the beam 16 are changed. Parameters that may be changed include, for example, the gain and/or pointing direction of an antenna providing the beam 16, the footprint of the beam 16, the elevation angle of the beam 16, the center of the beam's footprint, a reference location of the beam 16, the satellite or service link for the beam 16, etc. In this latter case, for instance, the reconfiguration of the beam 16 may comprise a switch of a service link supporting the beam 16 from a source satellite to a target satellite. Accordingly, service link switching is considered to be a type of beam reconfiguration.

In these and other embodiments, the beam 16 may be reconfigured in a way that impacts time and/or frequency synchronization for the beam 16. Time synchronization here concerns the wireless device's determination of the correct instants in time at which to sample a downlink signal from the network 10 and/or at which to transmit an uplink signal to the network 10. Timing errors would otherwise result in inter-symbol interference. Frequency synchronization concerns the wireless device's determination of the correct frequency and/or phase of its local carrier oscillator, e.g., to preserve subcarrier orthogonality and mitigate interchannel interference. In some embodiments, the wireless device 18 is configured to acquire such time and/or frequency synchronization for the beam 16 relative to a reference point for the beam 16, e.g., the center of the beam's footprint. In this case, any reconfiguration that changes the location of the beam's reference point, such as a reconfiguration that changes the location of the beam's footprint or the pointing direction of the antenna providing the beam 16, impacts the time and/or frequency synchronization for the beam 16.

According to some embodiments herein, the wireless communication network 10 informs the wireless device 18 about reconfiguration of the beam 16 serving the wireless device 18. The network 10 may for example inform the wireless device 18 about how and/or when the beam 18 is to be, or has been, reconfigured. This way, rather than insulating the wireless device 18 from knowledge of the beam reconfiguration, some embodiments equip the wireless device 18 with knowledge of the beam reconfiguration so as to trigger the wireless device 18 to reacquire time and/or frequency synchronization for the beam 16. Reacquiring synchronization for the beam 16 in this way may thereby adaptively account for beam reconfiguration that would have otherwise jeopardized synchronization. These and other embodiments may prove especially applicable in a non-terrestrial network. Indeed, in this case, embodiments herein may advantageously preserve flexibility to reconfigure beams of a multiple spot beam satellite while also preserving time and/or frequency synchronization.

More particularly, FIG. 1 shows that the network 10 includes a network node 20, which may for example be associated with the earth-based gateway 14 or with the satellite 12. Either way, the network node 20 according to embodiments herein transmits signaling 22 to the wireless device 18, e.g., upon determining that the beam 16 has been or is to be reconfigured. The signaling 22 indicates reconfiguration of the beam 16 serving the wireless device 18, e.g., via a beam reconfiguration indication 24. In some embodiments, the signaling 22 indicates reconfiguration of the beam 16 simply in the sense that the signaling 22 indicates the past, present, or future occurrence of that reconfiguration, e.g., without regard to how the beam has been or will be reconfigured. The signaling 22 may for example just indicate that the reconfiguration of the beam 16 is to occur, e.g., at some indefinite or unspecified point in the future. Or, the signaling 22 may more specifically indicate that the reconfiguration of the beam 16 is to occur at or after a certain time, e.g., the next system information modification period. In still other embodiments, the signaling 22 may indicate the value of a so-called beam activity timer, e.g., dedicated to controlling or supervising the timing of reconfiguration of the beam 16. The wireless device 18 may for instance be configured to start the timer with the indicated value upon reception of the signaling 22, where expiration of the timer means that the reconfiguration of the beam 16 has occurred or is occurring.

With regard to the timer-based approach, in some embodiments, the network 10 configures the wireless device 18 with a default beam configuration, e.g., including information such as reference location and a serving satellite ephemeris. In this case, the wireless device 18 may perform downlink reception and uplink transmission using an active beam configuration that is a non-default configuration. The wireless device 18 may then start or restart the timer after performing downlink reception or an uplink transmission using the active beam configuration. However, upon expiry of the beam activity timer, the wireless device 18 may apply the default beam configuration. The beam activity timer in this way indicates when the beam is to be reconfigured with the default configuration.

Note here that the signaling 22 may indicate reconfiguration of the beam 16 explicitly or implicitly. The signaling 22 may for example explicitly indicate occurrence of the reconfiguration using one or more information elements (IEs) that are dedicated to indicating occurrence of the reconfiguration and/or whose value directly indicates occurrence of the reconfiguration.

Alternatively, the signaling 22 may implicitly indicate occurrence of the reconfiguration using one or more IEs that are not dedicated to indicating occurrence of the reconfiguration and/or whose value directly indicates something other than occurrence of the reconfiguration, but occurrence of the reconfiguration can be assumed, inferred, or otherwise deduced therefrom. Such implicit indication thereby still informs the wireless device 18 about the beam reconfiguration. In one embodiment, for example, the signaling 22 implicitly indicates reconfiguration of the beam 16 by indicating a change in an identity of a cell served by the beam or a change in a service link supporting the beam 16. The signaling 22 in this case may include one or more IEs whose value directly indicates such a cell identity change and/or a service link change, but reconfiguration of the beam 16 may be assumed, inferred, or otherwise deduced as also occurring in conjunction with the cell identity change and/or the service link change.

The signaling 22 in still other embodiments may alternatively or additionally indicate information about how the beam has been or will be reconfigured, e.g., in terms of any one or more parameters governing configuration of the beam 16. In some embodiments, for instance, the signaling 22 indicates a change in a reference location of the beam 16, e.g., where the reference location is a location which serves as a common reference for time and/or frequency synchronization (common in the sense that it is common amongst wireless devices served by the beam 16). The reference location may for example be a location on the ground, a location in the sky, a location at the satellite 12, or even be a null location. In one specific example, the reference location is a center of the beam's footprint or the center of a cell served by the beam 16. Where the reference location is changed from an old location to a new location, the signaling 22 may for instance indicate the new location. Alternatively or additionally, the signaling 22 may indicate a change in an ephemeris of the satellite 12 providing the beam 16. Where the ephemeris is changed from an old ephemeris to a new ephemeris, the signaling 22 may for instance indicate the new ephemeris.

In some embodiment, the signaling 22 is broadcasted, e.g., to wireless devices served by the beam 16 and/or the network node 20. Alternatively or additionally, the signaling 22 may be included in System Information, e.g., in a Master Information Block (MIB) containing essential System Information for access, in a System Information Block #1 (SIB1) containing scheduling information for System Information Blocks, or in any System Information Block (SIB). The System Information may or may not be broadcasted. In other embodiments, the signaling 22 is dedicated Radio Resource Control (RRC) signaling, a Medium Access Control (MAC) Control Element (CE) command, a Downlink Control Information (DCI) message, or a combination thereof. In dedicated RRC signaling, the network 10 may use an RRC message to signal the information described above. Alternatively, the network 10 may use RRC reconfiguration signaling to directly deliver the changed information (e.g., System Information) about the beam reconfiguration. In a MAC CE command or DCI, the network 10 may indicate a beam reconfiguration command. The MAC CE command or DCI may further include the needed time and/or frequency adjustment after the beam reconfiguration.

In certain embodiments, then, the network 10 may provide an explicit indication using the signaling 22 (e.g., broadcast signaling) that the network 10 intends to perform a beam reconfiguration that may impact the downlink carrier frequency and downlink timing in a cell served by the beam 16. The signaling 22 may alternatively or additionally include information about the new reference location and the new serving satellite ephemeris upon the reconfiguration, if there are changes in the reference location and serving satellite. The signaling 22 may alternatively or additionally indicate the intended timing of the reconfiguration e.g. by means of existing system information modification indication signaling and timing.

In any event, responsive to receiving the signaling 22, the wireless device 18 according to some embodiments reacquires time and/or frequency synchronization for the beam 16, e.g., to account for the indicated reconfiguration of the beam 16. The signaling 22 may thereby prompt or trigger the wireless device 18 to reacquire time and/or frequency synchronization for the beam 16. The wireless device 18 in this regard may reacquire time and/or frequency synchronization in the downlink and/or in the uplink. Reacquiring downlink time and/or frequency synchronization for the beam 16 may involve, for instance, measuring one or more synchronization signals, and/or one or more reference signals, (collectively shown as signal(s) 26) transmitted to the wireless device 18 on the beam 16. With regard to downlink time synchronization, for example, the wireless device 18 may be able to use these measurements to estimate the timing of transmissions performed on the beam 16 in the downlink, e.g., in terms of a transmission timing structure. Alternatively or additionally, reacquiring uplink time and/or frequency synchronization for the beam 16 may involve receiving a timing advance and/or a frequency offset from the network node 20 or another node. The signaling 22 may for instance prompt or trigger the wireless device 18 to initiate a random access procedure (e.g., by transmitting a random access preamble) during which the wireless device 18 receives such a timing advance and/or frequency offset.

The wireless device's response to the signaling 22 may nonetheless depend on an RRC state of the wireless device 18. In some embodiments, for example, if the wireless device 18 is in an RRC idle or an RRC inactive state, the wireless device 18 may reacquire downlink time and/or frequency synchronization in response to receiving the signaling 22. If the wireless device 18 is in an RRC connected state, though, the wireless device 18 may also reacquire uplink time and/or frequency synchronization, e.g., to obtain a new timing advance (TA) value from the network 10.

No matter the particular way in which the wireless device 18 reacquires time and/or frequency synchronization, though, the wireless device 18 in some embodiments may then transmit and/or receive a transmission on the beam 16 based on the reacquired time and/or frequency synchronization for the beam 16. The wireless device 18 may for instance adjust a timing and/or frequency with which the wireless device 18 receives a signal on the beam 16 in the downlink and/or transmits a signal on the beam 16 in the uplink.

Some embodiments aim to ensure that this adjustment in time and/or frequency synchronization, triggered by a change in the configuration of the beam 16 from an old configuration to a new configuration, does not disrupt ongoing data transmission. In one or more embodiments, for example, the reconfiguration from the old configuration to the new configuration may be performed by simultaneously transmitting the beam 16 with the old configuration and transmitting the beam 16 with the new configuration. In some embodiments, transmission of the beam 16 with the old configuration may involve transmitting one or more signals on the beam 16 as configured with the old configuration, and transmission of the beam 16 with the new configuration may involve transmitting one or more signals on the beam 16 as configured with the new configuration. Regardless, with the beam 16 simultaneously transmitted with the old configuration and the new configuration, the network node 20 may then effectively steer the wireless device 18 to connect to the beam 16 with the new configuration.

For example, such steering may involve transmitting the beam 16 with the new configuration with a transmit power that is higher than a transmit power with which the network node 20 transmits the beam 16 with the old configuration. In one implementation, then, the power of the new beam (i.e., the beam 16 with the new configuration) may be increased during a time interval, and the power of the old beam (i.e., the beam 16 with the old configuration) may be decreased during another time interval. In these and other embodiments, if the beam reconfiguration includes or is associated with a change in the Physical Cell Identity (PCID) of a cell served by the beam 16, the wireless device 18 may detect the new PCID and perform a handover procedure, e.g., in Radio Resource Control (RRC) connected state. During this handover procedure, the wireless device 18 will be sent a new timing advance value and thereby acquire time synchronization for the beam 16 as reconfigured. In yet other embodiments, the network node 20 may steer the wireless device 18 to connected to the beam 16 with the new configuration by transmitting a Physical Downlink Control Channel (PDCCH) order that triggers the wireless device 18 to perform random access to the beam 16 with the new configuration. For example, if the beam reconfiguration does not include or is not associated with a change in the PCID, the network node 20 may send a PDCCH order to the wireless device 18 in RRC connected state. This PDCCH order may trigger random access in which the wireless device 18 transmits a random access preamble in the beam 16 with the new configuration and the network 10 in response to detecting the random access preamble signals a new TA value for the beam 16 with the new configuration.

Generally, then, some embodiments herein provide signaling methods for informing a wireless device 18 in a wireless communication network 10 (e.g., a non-terrestrial network) about a beam reconfiguration that impacts the device's time-frequency reference. After receiving signaling 20 informing the wireless device 18 of this, the wireless device 18 may trigger a procedure (e.g., a random access procedure) to update its time-frequency configuration. According to some embodiments, therefore, the network 10 indicates a beam reconfiguration to the wireless device 18 (e.g., including indicating a timing of the beam reconfiguration), the network 10 performs the beam reconfiguration, and the wireless device 18 reacquires time and/or frequency synchronization. In this way, some embodiments facilitate controlled network beam reconfiguration in a non-terrestrial network.

Consider in this regard additional details of some embodiments which may be realized in the context of 3GPP standardized operation of a Non-Terrestrial Network (NTN). In some embodiments, the wireless communication network 10 shown in FIG. 1 is a satellite radio access network. The network 10 in this case includes the satellite 12 or other space-borne platform, as well as the earth-based gateway 14. This gateway 14 connects the satellite 12 to a base station or a core network, depending on the choice of architecture. The network 10 may also include a feeder link (not shown) that refers to the link between the gateway 14 and the satellite 12. The network 10 may further include a service link (not shown) that refers to the link between the satellite 12 and the wireless device 18 (e.g., a user equipment, UE).

In some embodiments, the wireless communication network 10 has a Bent pipe transponder architecture. In this case, the base station is located on Earth behind the gateway 14, and the satellite 12 operates as a repeater forwarding the feeder link signal to the service link, and vice versa. In other embodiments, the wireless communication network 10 has a Regenerative transponder architecture. In this case, the satellite 12 is in the base station and the service link connects it to the earth-based core network. Accordingly, in some embodiments where the network node 20 in FIG. 1 is implemented as a base station, the network node 20 may be either located on Earth behind the gateway 14 (if the network 10 has the Bent pipe transponder architecture) or located at the satellite 12 (if the network 10 has the Regenerative transponder architecture).

Depending on the orbit altitude, the satellite 12 may be categorized as a low earth orbit (LEO), medium earth orbit (MEO), or geostationary earth orbit (GEO) satellite. LEO has typical heights ranging from 250-1,500 km, with orbital periods ranging from 90-120 minutes. MEO has typical heights ranging from 5,000-25,000 km, with orbital periods ranging from 3-15 hours. And GEO has a height at about 35,786 km, with an orbital period of 24 hours.

In some embodiments, the satellite 12 generates multiple (e.g., several) beams over a given area, i.e., the beam 16 is just one of multiple such beams. The footprint of any given beam may be in an elliptic shape, which may be considered as a cell. The footprint of a beam may be referred to as a spotbeam. The spotbeam may move over the earth surface with the satellite movement or may be earth fixed with some beam pointing mechanism used by the satellite 12 to compensate for its motion. The size of the spotbeam may depend on the system design, which may range from tens of kilometers to a few thousands of kilometers.

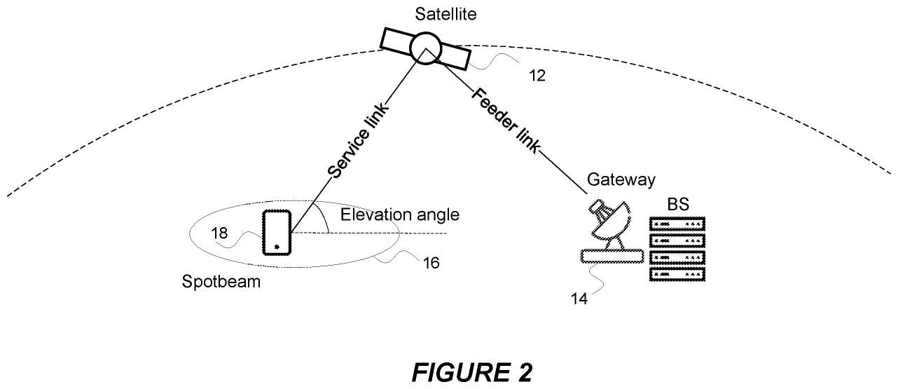

FIG. 2 shows a more specific example architecture of the wireless communication network 10 in the form of a satellite network with bent pipe transponders. The depicted elevation angle of the service link may affect the distance between the satellite 12 and the wireless device 18, and the velocity of the satellite 12 relative to the wireless device 18.

Some embodiments herein account for propagation delay as a physical phenomenon in wireless communication network 10. Where the network 10 is a satellite communication network, this propagation delay makes the radio access network design different from that of a terrestrial mobile system. The roundtrip-time (RTT) will depend on the NTN architecture used. For a bent pipe satellite network, the following delays are relevant: (i) one-way delay from the base station to the wireless device 18 via the satellite 12, or the other way around; and (ii) round-trip delay from the base station to the wireless device 18 via the satellite 12 and from the wireless device 18 back to the base station via the satellite 12. For a regenerative satellite network, the following delays are relevant: (i) one-way delay from the wireless device 18 to the satellite 12, or the other way around; and (ii) round-trip delay from the wireless device 18 to the satellite 12 and back to the wireless device 18, or the other way around.

There may be additional delay between the ground base station (BS) antenna and BS, which may or may not be collocated. This delay depends on deployment and may be taken into account in the communications system design.

Table 1 shows propagation delay examples for non-geostationary (NGSO) satellites (See Table 5.3.4.1-1 in 3GPP TR 38.811 v15.2.0, Study on New Radio (NR) to support non-terrestrial networks).

TABLE 1

| | LEO at 600 km | | LEO at 1500 km | | MEO at 10000 km | |
|---|---|---|---|---|---|---|
| | Distance D | Delay | Distance | Delay | Distance D | Delay |
| Path | (km) | (ms) | D (km) | (ms) | (km) | (ms) |

Bent pipe satellite

| | | | | | | | |
|---|---|---|---|---|---|---|---|
| One way | Gateway- | 4261.2 | 14.204 | 7749.2 | 25.83 | 28557.6 | 95.192 |
| delay | satellite UE | | | | | | |
| Round | Twice | 8522.5 | 28.408 | 15498.4 | 51.661 | 57115.2 | 190.38 |
| Trip Delay | | | | | | | |

Regenerative satellite

| | | | | | | | |
|---|---|---|---|---|---|---|---|
| One way | Satellite-UE | 1932.24 | 6.44 | 3647.5 | 12.16 | 14018.16 | 46.73 |
| delay | | | | | | | |
| Round | Satellite- | 3864.48 | 12.88 | 7295 | 24.32 | 28036.32 | 93.45 |
| Trip Delay | UE-Satellite | | | | | | |

Observe from Table 1 that the exemplified round-trip delays which apply at 90 degrees elevation angle are much larger in satellite systems compared with terrestrial systems. At lower elevation angles, the delays further increase. In contrast, the round-trip time is normally no more than 1 ms for typical terrestrial cellular networks.

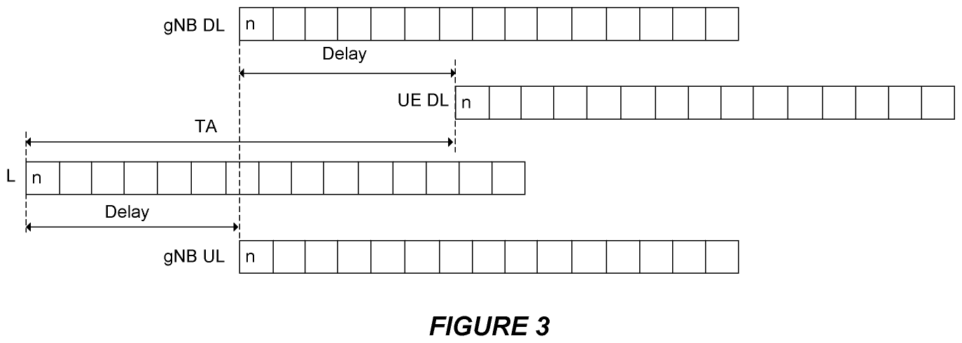

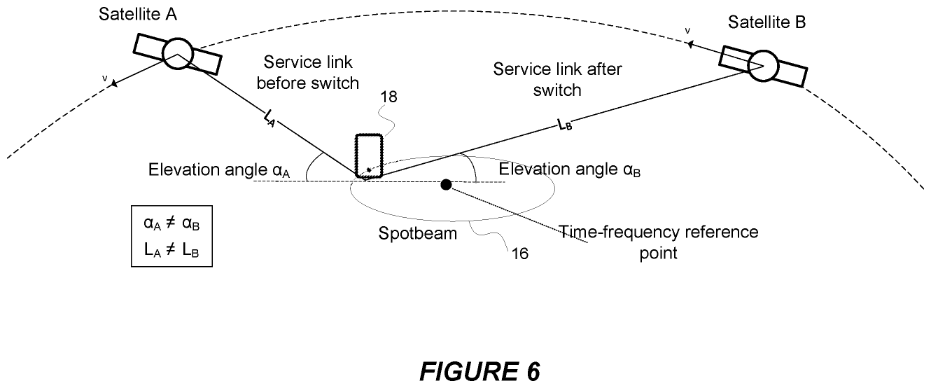

In some embodiments, such as where the wireless communication network 10 is a 3GPP terrestrial network, it the wireless device's responsibility to account for the RTT under network control. The wireless device 18 in this case may shift its uplink transmission frame structure compared to its downlink receiving frame structure. The shift corresponds to the timing advance (TA) command signalled from the network 10. The TA corresponds to the round-trip time between the base station and the wireless device 18. In an NTN, though, this design calls for a large shift in the wireless device's UL frame structure. FIG. 3 illustrates this case. In particular, FIG. 3 illustrates a wireless device shift of UL and DL frame structures according to a TA command, where the base station corresponds to a gNB and the wireless device 18 is exemplified as a UE. See FIG. 6.2.1-1 in 3GPP TR 38.821 v16.0.0, Solutions for NR to support non-terrestrial networks.

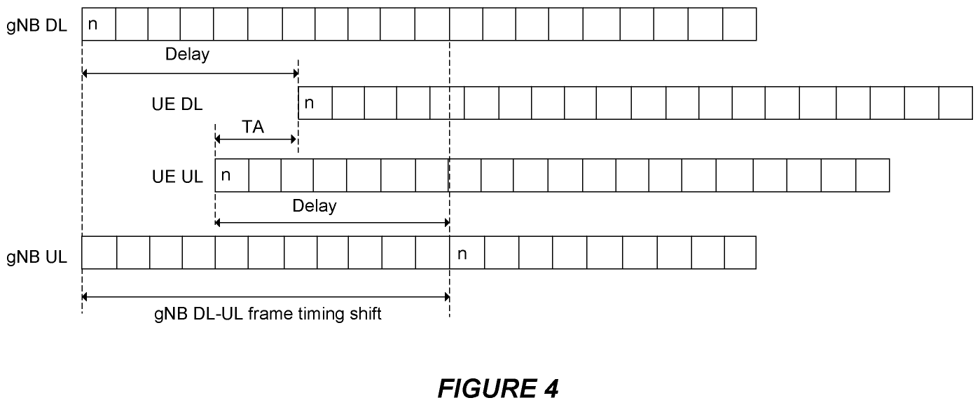

In other embodiments, such as those where the wireless communication network 10 is an NTN network, the impact on the wireless device 18 is reduced. In this case, the network 10 shifts its UL and DL frame structures relative to each other according to a reference delay, e.g. the RTT between the base station and some reference point on earth e.g. the centre of the beam 16, which may be a spot beam. The wireless device 18 in the same beam 16 may also adjust its UL-DL frame timing according to a TA that corresponds to the residual timing difference between the reference RTT and the wireless device's actual RTT. FIG. 4 illustrates this case, where the base station corresponds to a gNB and the wireless device 18 is exemplified as a UE. In particular, FIG. 4 shows a base station and wireless device shift of UL and DL frame structures in a 3GPP NR NTN. See, e.g., FIG. 6.2.1-1 in 3GPP TR 38.821 v16.0.0, Solutions for NR to support non-terrestrial networks. Note that, in case the wireless device 18 is located in the centre of the beam 16, the residual timing error corresponding to the illustrated TA value would be zero.

Some embodiments herein also account for NTN Doppler shift. In this regard, in a LEO NTN the satellites are moving with a velocity of approximately 7.1 km/s. This leads to relativistic effects, including a Doppler shift of the carrier frequency on the service link of up to 24 ppm for a LEO satellite at 600 km altitude. 3GPP TR 38.821 v16.0.0. The Doppler shift is also time variant due to the satellite motion over the sky. The Doppler shift may vary with up to 0.27 ppm/s for a LEO 600 km satellite. The Doppler shift will impact, i.e., increase or decrease, the frequency received on the service link compared to the transmitted frequency. Also, the service link timing will be impacted by the satellite velocity. In case the satellite moves towards the receiver (e.g., wireless device 18) an increase in the observed frequency will be experienced, and time will appear to run faster in the receiver compared to the transmitter.

Similar to the delay compensation, the base station can compensate also for the just mentioned time-frequency effects. Again, the compensation would apply for a reference point e.g. the spotbeam centre where the wireless device 18 would not experience any Doppler shift thanks the mentioned compensation. The residual Doppler experienced by the wireless device 18 may depend on the device's location relative to the chosen reference point.

Note here that the satellite 12 may support tens or even hundreds of spotbeams on the service link in some embodiments. The satellite 12 may also be able to flexibly change the location and size of each of the spotbeams. In a phased array antenna implementation this may e.g. be achieved by reconfiguring the antenna precoding weights.

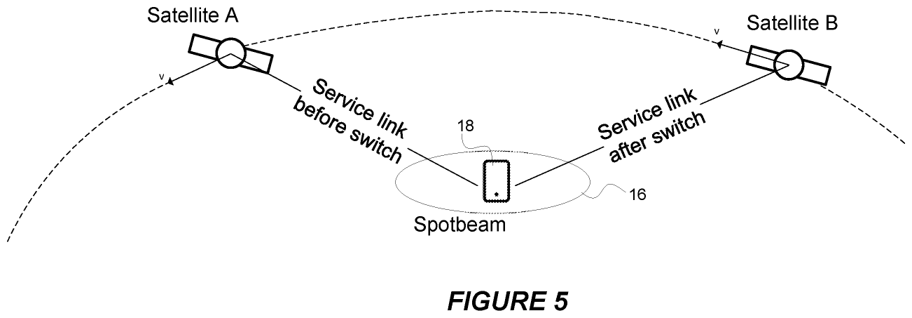

A reconfiguration of the beam 16 (e.g., a spotbeam) may e.g. occur at a service link switch from a first to a second satellite as shown in FIG. 5. FIG. 5 in particular Illustrates service link switching where the beam 16 is an earth-fixed beam. The movements of the satellites are illustrated using vectors v. In these and other embodiments, reconfiguration of the beam 16 can be triggered by a requirement to improve the link budget in a cell by means of increasing the satellite antenna gain which corresponds to a reduction in the half-power beam width and the cell size. The beam 16 can also be refocused towards an area of high mobile traffic density to improve the link budget in that area.

Reconfiguration of the beam 16 will however affect the timing and frequency of a cell served by the beam 16, e.g., in the form of a spot beam. Consider an embodiment where the wireless device 18 is located at the cell edge in the case of a service link switch, as shown in FIG. 6. The wireless device 18 will first experience a change in its residual timing relative to the cell center since it will be at different distances relative to the serving satellite before and after the service link switch. It will also experience a change in the carrier frequency since the residual Doppler is dependent on the elevation angle which is different before and after the service link switch. Similar examples can be made for other type of beam reconfigurations.

Some embodiments avoid a beam reconfiguration being performed transparently to wireless devices in the network 10. Some embodiments thereby avoid a scenario where the wireless device 18 is not aware of the impact on timing and/or carrier frequency caused by a beam reconfiguration. Some embodiments therefore prevent a wireless device in RRC connected state from dropping a connection due to the beam reconfiguration and its impact on time and/or frequency synchronization. For a wireless device in RRC idle or RRC inactive state, some embodiments advantageously prevent failure of an access attempt due to the beam reconfiguration and its impact on time and/or frequency synchronization. Indeed, according to some embodiments herein, signaling methods may inform wireless devices in the network 10 (e.g., a 3GPP NTN) about an intended beam reconfiguration. After receiving this signaling, the wireless device 18 may trigger a procedure to update its time-frequency configuration.

Note that, as used herein, a transmission timing structure may comprise a plurality of symbols, and/or define an interval comprising several symbols (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronization structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signaling is received, e.g. in relation to the timing grid. A transmission timing structure may in particular be a slot or subframe or in some cases, a mini-slot.

References to specific resource structures like transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), subframe, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4 symbols. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots.

In general, a numerology and/or subcarrier spacing may indicate the bandwidth (in frequency domain) of a subcarrier of a carrier, and/or the number of subcarriers in a carrier and/or the numbering of the subcarriers in a carrier. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

Signaling may generally be considered to represent an electromagnetic wave structure (e.g., over a time interval and frequency interval), which is intended to convey information to at least one specific or generic (e.g., anyone who might pick up the signaling) target. A process of signaling may comprise transmitting the signaling. Transmitting signaling, in particular control signaling or communication signaling may comprise encoding and/or modulating. Encoding and/or modulating may comprise error detection coding and/or forward error correction encoding and/or scrambling. Receiving control signaling may comprise corresponding decoding and/or demodulation. Error detection coding may comprise, and/or be based on, parity or checksum approaches, e.g. CRC (Cyclic Redundancy Check). Forward error correction coding may comprise and/or be based on for example turbo coding and/or Reed-Muller coding, and/or polar coding and/or LDPC coding (Low Density Parity Check). The type of coding used may be based on the channel (e.g., physical channel) the coded signal is associated to.

Example types of signaling comprise signaling of a specific communication direction, in particular, uplink signaling, downlink signaling, sidelink signaling, as well as reference signaling (e.g., SRS or CRS or CSI-RS), communication signaling, control signaling, and/or signaling associated to a specific channel like PUSCH, PDSCH, PUCCH, PDCCH, PSCCH, PSSCH, etc.). Here, SRS refers to a Sounding Reference Signal, CRS refers to a Cell-Specific Reference Signal, and a CSI-RS refers to Channel State Information Reference Signal. Moreover, PUSCH refers to a Physical Uplink Shared Channel, PDSCH refers to a Physical Downlink Shared Channel, PUCCH refers to a Physical Uplink Control Channel, PSCCH refers to a Physical Sidelink Control Channel, and PSSCH refers to a Physical Sidelink Shared Channel.

Communication signaling may comprise, and/or represent, and/or be implemented as, data signaling, and/or user plane signaling. Communication signaling may be associated to a data channel, e.g. a physical downlink channel or physical uplink channel or physical sidelink channel, in particular a PDSCH (Physical Downlink Shared Channel) or PSSCH (Physical Sidelink Shared Channel). Generally, a data channel may be a shared channel or a dedicated channel. Data signaling may be signaling associated to and/or on a data channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information. It may in particular be considered that control signaling as described herein, based on the utilized resource sequence, implicitly indicates the control signaling type.

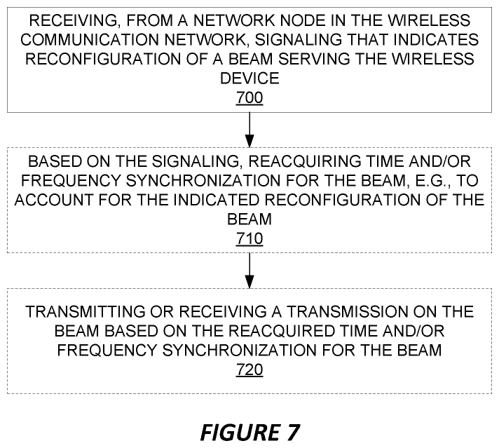

In view of the above modifications and variations, FIG. 7 depicts a method performed by a wireless device 18 configured for use in a wireless communication network 10 in accordance with particular embodiments. The method includes receiving, from a network node 20 in the wireless communication network 10, signaling 22 that indicates reconfiguration of a beam 16 serving the wireless device 18 (Block 700). In some embodiments, the method may also include, based on the signaling 22, reacquiring time and/or frequency synchronization for the beam 16, e.g., to account for the indicated reconfiguration of the beam 16 (Block 710). The method in one or more embodiments may further comprise transmitting or receiving a transmission on the beam 16 based on the reacquired time and/or frequency synchronization for the beam 16 (Block 720).

In some embodiments, the signaling 22 indicates that the reconfiguration of the beam 16 is to occur.

In some embodiments, the signaling 22 indicates that the reconfiguration of the beam 16 is to occur at or after a certain time.

In some embodiments, the signaling 22 indicates a value of a beam activity timer. This beam activity timer indicates when the beam 16 is to be reconfigured with a default configuration. In this case, the method may further comprise starting or restarting the beam activity timer with the indicated value upon performing downlink reception or uplink transmission on the beam 16 using a non-default configuration of the beam 16. And reacquiring time and/or frequency synchronization may comprise reacquiring time and/or frequency synchronization for the beam 16 responsive to expiration of the timer.

In some embodiments, the signaling 22 indicates a change in a reference location of the beam 16, where the reference location is a location which serves as a common reference for time and/or frequency synchronization.

In some embodiments, the signaling 22 indicates a change in an ephemeris of a satellite providing the beam 16.

In some embodiments, the signaling 22 implicitly indicates reconfiguration of the beam 16 by indicating a change in an identity of a cell served by the beam 16 or a change in a service link supporting the beam 16.

In some embodiments, the signaling 22 is broadcasted to wireless devices served by the beam 16.

In some embodiments, the signaling 22 comprises system information.

In some embodiments, the signaling 22 comprises Radio Resource Control signaling, or a Medium Access Control, MAC, Control Element command, or a Downlink Control Information message, or a combination thereof.

In some embodiments, the reconfiguration changes a footprint of and/or elevation angle of the beam 16.

In some embodiments, the reconfiguration comprises a switch of a service link supporting the beam 16 from a source satellite to a target satellite.

In some embodiments, the reconfiguration comprises a reconfiguration of a gain or pointing direction of an antenna providing the beam 16.

In some embodiments, reacquiring time and/or frequency synchronization for the beam 16 comprises reacquiring downlink time and/or frequency synchronization for the beam 16.

In some embodiments, reacquiring time and/or frequency synchronization for the beam 16 comprises reacquiring uplink time and/or frequency synchronization for the beam 16.

In some embodiments, the method further comprises transmitting or receiving a transmission on the beam 16 based on the reacquired time and/or frequency synchronization for the beam 16.

In some embodiments, the wireless communication network 10 is a non-terrestrial wireless communication network.

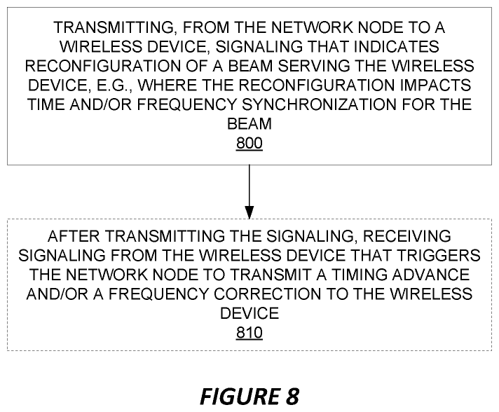

FIG. 8 depicts a method performed by a network node 20 configured for use in a wireless communication network 10 in accordance with other particular embodiments. The method includes transmitting, from the network node 20 to a wireless device 18, signaling 22 that indicates reconfiguration of a beam 16 serving the wireless device 18, e.g., where the reconfiguration impacts time and/or frequency synchronization for the beam 16 (Block 800). In some embodiments, the method further comprises, after transmitting the signaling 22, receiving signaling from the wireless device 18 that triggers the network node 20 to transmit a timing advance and/or a frequency correction to the wireless device 18 (Block 810).

In some embodiments, the signaling 22 indicates that the reconfiguration of the beam 16 is to occur. In this case, the method may comprise transmitting the signaling 22 before performing the reconfiguration of the beam 16.

In some embodiments, the signaling 22 indicates that the reconfiguration of the beam 16 is to occur at or after a certain time.

In some embodiments, the signaling 22 indicates a value of a beam activity timer that controls when the beam 16 is to be reconfigured with a default configuration. In this case, the beam activity timer is to be started or restarted with the indicated value upon performing downlink reception or uplink transmission on the beam 16 using a non-default configuration of the beam 16. And the beam 16 is to be reconfigured with the default configuration responsive to expiration of the timer.

In some embodiments, the signaling 22 indicates a change in a reference location of the beam 16, where the reference location is a location which serves as a common reference for time and/or frequency synchronization.

In some embodiments, the signaling 22 indicates a change in an ephemeris of a satellite providing the beam 16.

In some embodiments, the signaling 22 implicitly indicates reconfiguration of the beam 16 by indicating a change in an identity of a cell served by the beam 16 or a change in a service link supporting the beam 16.

In some embodiments, transmitting the signaling 22 comprises broadcasting the signaling 22.

In some embodiments, the signaling 22 comprises system information.

In some embodiments, the signaling 22 comprises Radio Resource Control signaling, or a Medium Access Control, MAC, Control Element command, or a Downlink Control Information message, or a combination thereof.

In some embodiments, the reconfiguration changes a footprint of and/or elevation angle of the beam 16.

In some embodiments, the reconfiguration comprises a switch of a service link supporting the beam 16 from a source satellite to a target satellite.

In some embodiments, the reconfiguration comprises a reconfiguration of a gain or pointing direction of an antenna providing the beam 16.

In some embodiments, the method further comprises, after transmitting the signaling 22, receiving signaling 22 from the wireless device 18 that triggers the network node 20 to transmit a timing advance and/or a frequency correction to the wireless device 18.

In some embodiments, the time and/or frequency synchronization for the beam 16 comprises downlink time and/or frequency synchronization.

In some embodiments, the time and/or frequency synchronization for the beam 16 comprises uplink time and/or frequency synchronization.

In some embodiments, reconfiguration of the beam 16 changes a configuration of the beam 16 from an old configuration to a new configuration. In this case, the method may further comprise simultaneously transmitting the beam 16 with the old configuration and transmitting the beam 16 with the new configuration; and steering the wireless device 18 to connect to the beam 16 with the new configuration. In some embodiments, such steering comprises transmitting the beam 16 with the new configuration with a transmit power that is higher than a transmit power with which the network node 20 transmits the beam 16 with the old configuration. In other embodiments, such steering comprises transmitting a Physical Downlink Control Channel, PDCCH, order that triggers the wireless device 18 to perform random access to the beam 16 with the new configuration.

In some embodiments, the wireless communication network 10 is a non-terrestrial wireless communication network.

In some embodiments, the signaling 22 is to trigger the wireless device 18 to reacquire time and/or frequency synchronization for the beam 16.

Embodiments herein also include corresponding apparatuses. Embodiments herein for instance include a wireless device 18 configured to perform any of the steps of any of the embodiments described above for the wireless device 18.

Embodiments also include a wireless device 18 comprising processing circuitry and power supply circuitry. The processing circuitry is configured to perform any of the steps of any of the embodiments described above for the wireless device 18. The power supply circuitry is configured to supply power to the wireless device 18.

Embodiments further include a wireless device 18 comprising processing circuitry. The processing circuitry is configured to perform any of the steps of any of the embodiments described above for the wireless device 18. In some embodiments, the wireless device 18 further comprises communication circuitry.

Embodiments further include a wireless device 18 comprising processing circuitry and memory. The memory contains instructions executable by the processing circuitry whereby the wireless device 18 is configured to perform any of the steps of any of the embodiments described above for the wireless device 18.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 18. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 20 configured to perform any of the steps of any of the embodiments described above for the network node 20.

Embodiments also include a network node 20 comprising processing circuitry and power supply circuitry. The processing circuitry is configured to perform any of the steps of any of the embodiments described above for the network node 20. The power supply circuitry is configured to supply power to the network node 20.

Embodiments further include a network node 20 comprising processing circuitry. The processing circuitry is configured to perform any of the steps of any of the embodiments described above for the network node 20. In some embodiments, the network node 20 further comprises communication circuitry.

Embodiments further include a network node 20 comprising processing circuitry and memory. The memory contains instructions executable by the processing circuitry whereby the network node 20 is configured to perform any of the steps of any of the embodiments described above for the network node 20.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

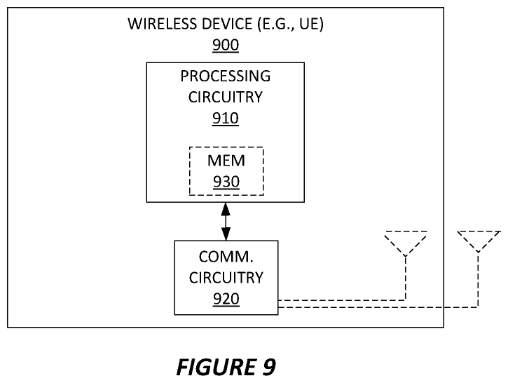

FIG. 9 for example illustrates a wireless device 900 (e.g., wireless device 18) as implemented in accordance with one or more embodiments. As shown, the wireless device 900 includes processing circuitry 910 and communication circuitry 920. The communication circuitry 920 (e.g., radio circuitry) is configured to transmit and/or receive information to and/or from one or more other nodes, e.g., via any communication technology. Such communication may occur via one or more antennas that are either internal or external to the wireless device 900. The processing circuitry 910 is configured to perform processing described above, e.g., in FIG. 7, such as by executing instructions stored in memory 930. The processing circuitry 910 in this regard may implement certain functional means, units, or modules.

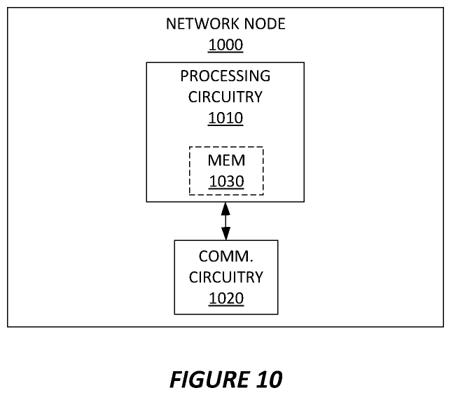

FIG. 10 illustrates a network node 1000 (e.g., network node 20) as implemented in accordance with one or more embodiments. As shown, the network node 1000 includes processing circuitry 1010 and communication circuitry 1020. The communication circuitry 1020 is configured to transmit and/or receive information to and/or from one or more other nodes, e.g., via any communication technology. The processing circuitry 1010 is configured to perform processing described above, e.g., in FIG. 8, such as by executing instructions stored in memory 1030. The processing circuitry 1010 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

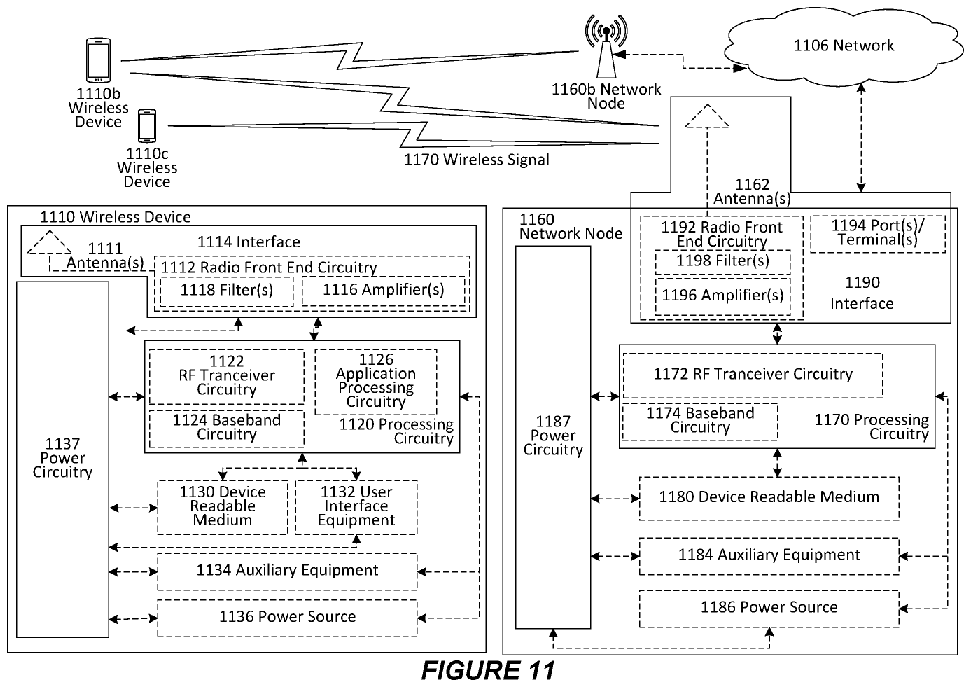

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 11 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

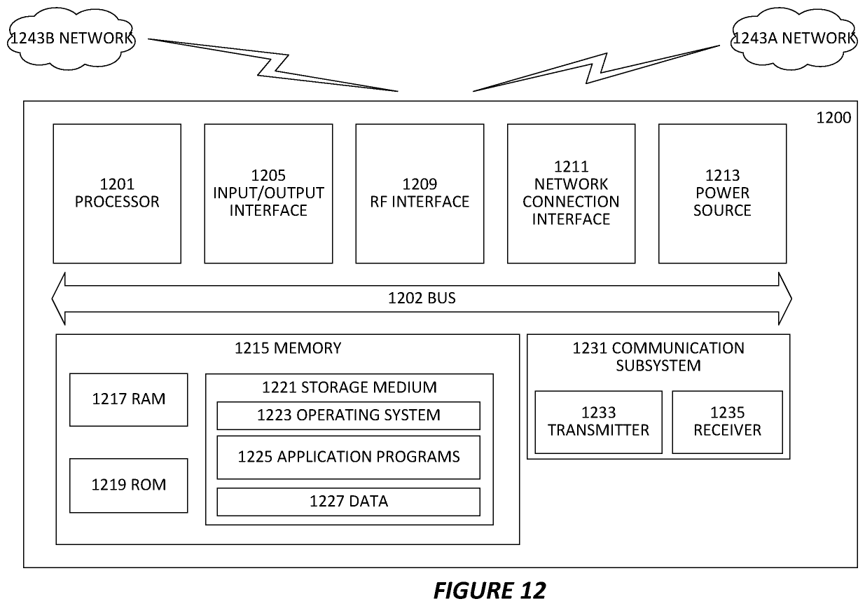

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 12, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 12, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

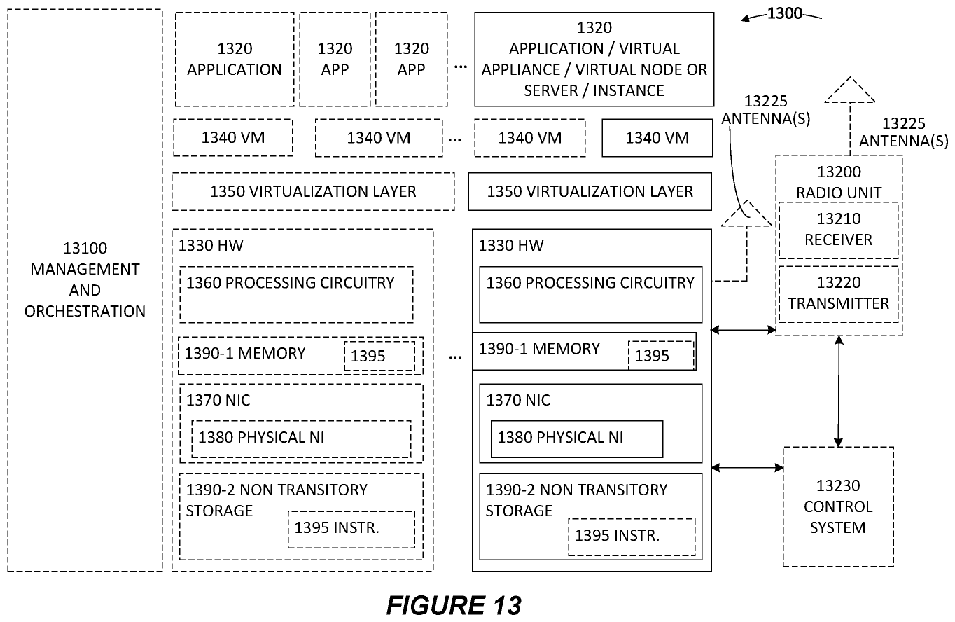

FIG. 13 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 13, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

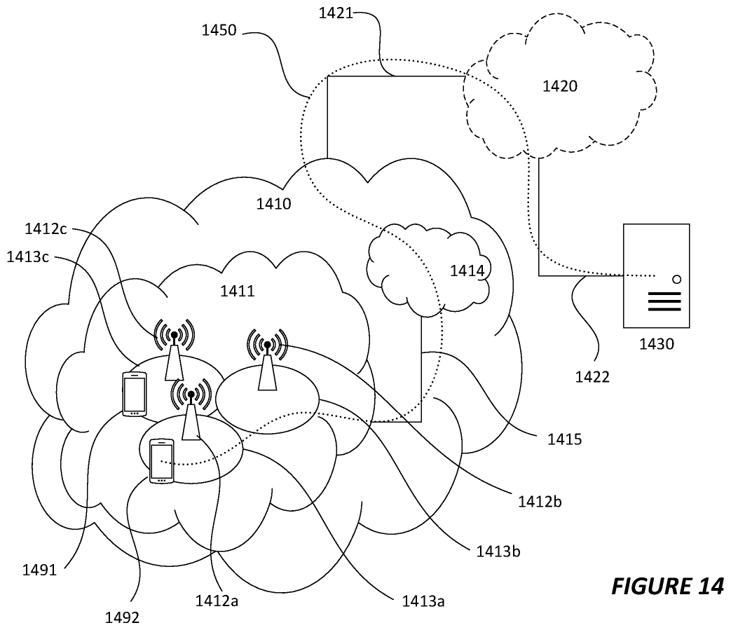

FIG. 14 illustrates a telecommunication network connected via an intermediate network to a host computer in accordance with some embodiments. In particular, with reference to FIG. 14, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 14 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

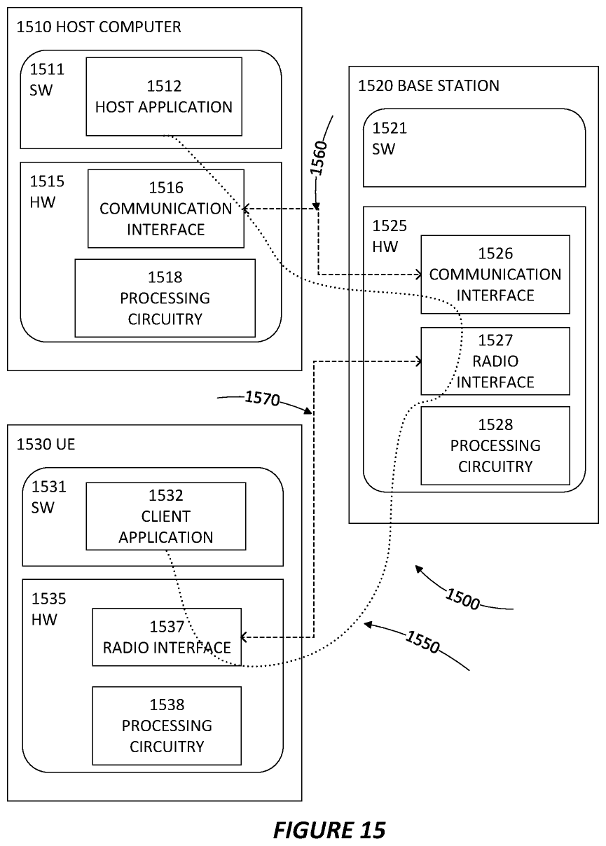

Example implementations, in accordance with an embodiment, of the UE, base station and host computer discussed in the preceding paragraphs will now be described with reference to FIG. 15. FIG. 15 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 15) served by base station 1520. Communication interface 1526 may be configured to facilitate connection 1560 to host computer 1510. Connection 1560 may be direct or it may pass through a core network (not shown in FIG. 15) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 15 may be similar or identical to host computer 1430, one of base stations 1412a, 1412b, 1412c and one of UEs 1491, 1492 of FIG. 14, respectively. This is to say, the inner workings of these entities may be as shown in FIG. 15 and independently, the surrounding network topology may be that of FIG. 14.

In FIG. 15, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

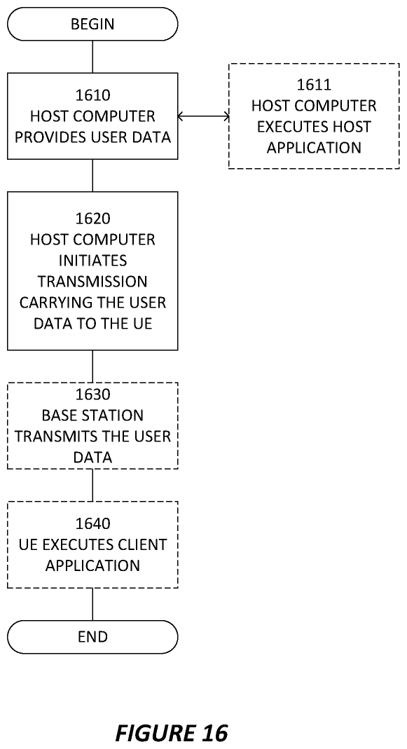

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

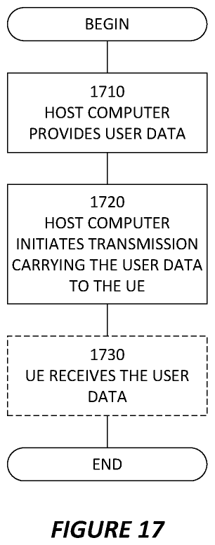

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

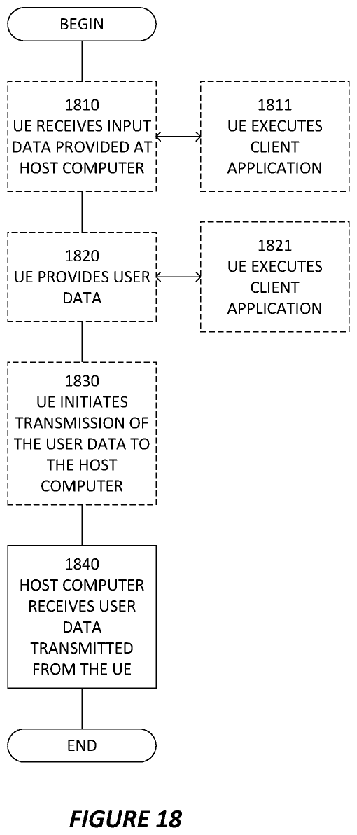

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

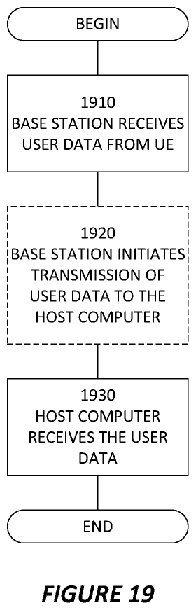

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1.-33. (canceled)

34. A method performed by a wireless device configured for use in a wireless communication network, the method comprising:
receiving, from a network node in the wireless communication network, signaling that indicates reconfiguration of a beam serving the wireless device; and
based on the signaling, reacquiring time and/or frequency synchronization for the beam, to account for the indicated reconfiguration of the beam.

35. The method of claim 34, wherein the signaling indicates a change in a reference location of the beam, wherein the reference location is a location which serves as a common reference for time and/or frequency synchronization.

36. The method of claim 34, wherein the signaling indicates a change in an ephemeris of a satellite providing the beam.

37. The method of claim 34, wherein the signaling implicitly indicates reconfiguration of the beam by indicating a change in an identity of a cell served by the beam or a change in a service link supporting the beam.

38. The method of claim 34, wherein the signaling is broadcasted to wireless devices served by the beam.

39. The method of claim 34, wherein the reconfiguration:
changes a footprint of and/or elevation angle of the beam; and/or
comprises a switch of a service link supporting the beam from a source satellite to a target satellite; and/or
comprises a reconfiguration of a gain or pointing direction of an antenna providing the beam.

40. The method of claim 34, further comprising transmitting or receiving a transmission on the beam based on the reacquired time and/or frequency synchronization for the beam.

41. The method of claim 34, wherein the wireless communication network is a non-terrestrial wireless communication network.

42. A method performed by a network node configured for use in a wireless communication network, the method comprising:
transmitting, from the network node to a wireless device, signaling that indicates reconfiguration of a beam serving the wireless device, wherein the reconfiguration impacts time and/or frequency synchronization for the beam.

43. The method of claim 42, wherein the signaling indicates a value of a beam activity timer that controls when the beam is to be reconfigured with a default configuration, wherein the beam activity timer is to be started or restarted with the indicated value upon performing downlink reception or uplink transmission on the beam using a non-default configuration of the beam, and wherein beam is to be reconfigured with the default configuration responsive to expiration of the timer.

44. The method of claim 42, wherein the signaling indicates a change in an ephemeris of a satellite providing the beam.

45. The method of claim 42, wherein the signaling implicitly indicates reconfiguration of the beam by indicating a change in an identity of a cell served by the beam or a change in a service link supporting the beam.

46. The method of claim 42, wherein the reconfiguration:
changes a footprint of and/or elevation angle of the beam; and/or
comprises a switch of a service link supporting the beam from a source satellite to a target satellite; and/or
comprises a reconfiguration of a gain or pointing direction of an antenna providing the beam.

47. The method of claim 42, further comprising, after transmitting the signaling, receiving signaling from the wireless device that triggers the network node to transmit a timing advance and/or a frequency correction to the wireless device.

48. The method of claim 42, wherein reconfiguration of the beam changes a configuration of the beam from an old configuration to a new configuration, and wherein the method further comprises:
simultaneously transmitting the beam with the old configuration and transmitting the beam with the new configuration; and
steering the wireless device to connect to the beam with the new configuration.

49. The method of claim 42, wherein the wireless communication network is a non-terrestrial wireless communication network.

50. A wireless device configured for use in a wireless communication network, the wireless device comprising:
communication circuitry; and
processing circuitry configured to:
receive, from a network node in the wireless communication network, signaling that indicates reconfiguration of a beam serving the wireless device; and
based on the signaling, reacquire time and/or frequency synchronization for the beam, to account for the indicated reconfiguration of the beam.

51. The wireless device of claim 50, wherein the wireless communication network is a non-terrestrial wireless communication network.

52. A network node configured for use in a wireless communication network, the network node comprising:
communication circuitry; and
processing circuitry configured to transmit, from the network node to a wireless device, signaling that indicates reconfiguration of a beam serving the wireless device, wherein the reconfiguration impacts time and/or frequency synchronization for the beam.

53. The network node of claim 52, wherein the wireless communication network is a non-terrestrial wireless communication network.
